(19) United States
(12) Patent Application Publication
(10) Pub. No.: US 2009/0171854 A1
(43) Pub. Date: Jul. 2, 2009

(54) Increasing health insurance benefits

(76) Inventors: Victor Joseph, Fremont, CA (US); Amjad Huda, Fremont, CA (US); Azhar Huda, Fremont, CA (US); Pia Annamkutty Victor, Fremont, CA (US); Joy Joseph Victor, Fremont, CA (US)

Correspondence Address: Ashok Tankha, Of Counsel, Lipton, Weinberger & Husick, 36 Greenleigh Drive, Sewell, NJ, 08080, US

(21) Appl. No.: 12/005,789

(22) Filed: Dec. 29, 2007

(51) Int. Cl. G06Q 10/00; G06Q 40/00

(52) U.S. Cl. 705/80; 705/4

(57) ABSTRACT

Disclosed herein is a computer implemented method and system for providing increased health insurance benefits to employees of business entities for an insurance premium charge. A third party collects health plan requirements and critical health information from the employees. The third party then proposes health plans from health insurance companies to the business entities. Each employee of the business entities chooses a health plan. The third party combines the employees into groups based on the chosen health plans and geographic location of the business entities. The third party negotiates with the health insurance companies regarding health insurance benefits and insurance premium charges offered for the combined employee groups. Authorized personnel may be provided access to the critical health information of the employees. The access to the critical health information improves quality of health care provided to the employees by the attending physicians and reduces the liability to health insurance companies.

### BACKGROUND

This invention generally relates to health insurance management. More particularly, this invention relates to providing increased health insurance benefits to employees of business entities, in general, for an insurance premium charge.

Typically, health insurance companies provide health insurance coverage to individuals, families, and employees of business entities. Generally, larger business entities with a larger employee pool receive better cost benefits and health insurance coverage for their employees from the health insurance companies. Smaller business entities, typically, with a smaller employee pool, receive lower health insurance coverage at higher cost for their employees from the health insurance companies. Further, periodic work force reductions may increase the health insurance costs for the business entities. The health insurance companies and attending physicians may require access to medical history of the employees for critical health conditions of the employees prior to enrollment or treatment.

Hence, there is an unmet need for a method and a system to increase insurance benefits to employees of business entities. Further, there is a need to provide access to critical health information of the employees where a critical health condition exists in order to improve quality of health care provided to the employees by the attending physicians and to reduce the liability to health insurance companies.

### SUMMARY OF THE INVENTION

The computer implemented method and system disclosed herein, addresses the above stated need for increasing insurance benefits to employees of business entities. Further, the method and system disclosed herein addresses the need for providing online access to critical health information of employees where a critical health condition exists in order to improve quality of health care provided to the employees by the attending physicians and to reduce the liability of health insurance companies.

In the computer implemented method and system disclosed herein, a third party collects health plan requirements from employees of business entities. The third party may be one or more of an individual, an insurance agent, a health maintenance organization, or a participating provider organization. The business entities may be one or more of companies, governmental organizations, non-governmental organizations, shops and stores, or institutions.

Based on the health plan requirements of the employees, the third party proposes health plans from multiple health insurance companies to the business entities. Each of the employees of the business entities chooses a health plan. The third party then combines the employees of the different business entities into groups based on the chosen health plans and geographic location of the business entities. Further, the third party negotiates with the health insurance companies regarding the health insurance benefits and insurance premium charges offered for the combined employee groups.

Further, the third party may also collect identification information and critical health information from the employees. The identification information of the employees includes biological identification information, physical identification information, hand written signatures, and personal identification information of the employees. The identification information is used to authenticate the employees by authorized personnel. The authorized personnel including the health insurance companies are provided online access to the critical health information during critical conditions of the employees. The online access to the critical health information of the employees improves quality of health care provided to the employees by the attending physicians and reduces the liability of the health insurance companies.

### BRIEF DESCRIPTION OF THE DRAWINGS

The foregoing summary, as well as the following detailed description of the embodiments, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a computer implemented method of providing increased health insurance benefits to employees of business entities for an insurance premium charge.

FIG. 2 illustrates a computer implemented system for providing increased health insurance benefits to employees of business entities for an insurance premium charge.

FIG. 3 exemplarily illustrates a flow chart of the steps involved in increasing benefits to the employees of companies.

FIG. 4 exemplarily illustrates a flow chart of the steps involved in providing emergency care to an employee by utilizing health care information of the employee collected by the third party.

FIG. 5 exemplarily illustrates the employee pool data used by a third party for negotiating with health insurance companies regarding health insurance benefits and insurance premium charges.

### DETAILED DESCRIPTION OF THE INVENTION

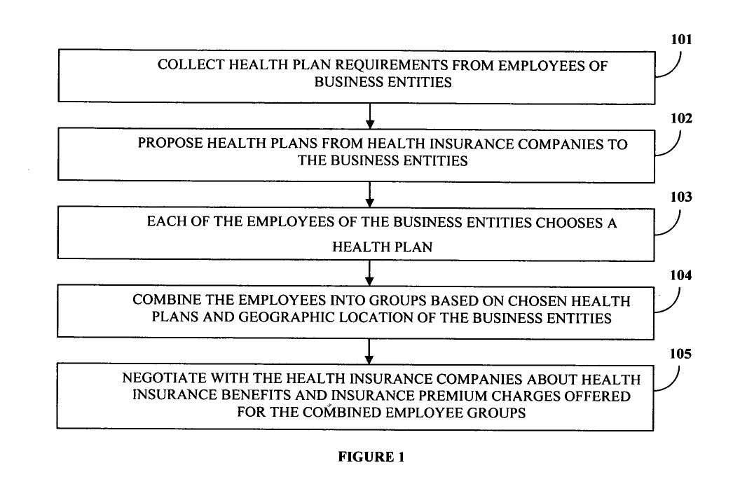

FIG. 1 illustrates a computer implemented method of providing increased health insurance benefits to employees of business entities for an insurance premium charge. In the method disclosed herein, a third party 300 collects 101 health plan requirements from employees of the business entities. The third party 300 may be an individual, an insurance agent, a health maintenance organization, or a participating provider organization. The business entities may be companies, governmental organizations, non-governmental organizations, shops and stores, or institutions.

Based on the collected health plan requirements of the employees, the third party 300 proposes 102 health plans from multiple health insurance companies to the business entities. Each of the employees of the business entities chooses 103 a health plan. The third party 300 combines 104 the employees into groups based on the chosen health plans and geographic location of the business entities. The step of combining the employees into groups comprises selecting employees from one or more of the business entities. The groups may include groups for premium reduction via group insurance, groups to cover uninsured individuals, groups for universal health coverage, or medicare groups. Further, the third party 300 negotiates 105 with the health insurance companies regarding the health insurance benefits and insurance premium charges offered for the combined employee groups.

The third party 300 may negotiate with health insurance companies regarding the availability of critical health information collected from the employees. The third party 300 may also negotiate with the health insurance companies regarding health insurance benefits and insurance premium charges offered for one or more of family members of the employees and unemployed individuals. The health plans provided based on combined employee groups of multiple companies increases the health insurance coverage and benefits for the employees and reduces insurance premium charges for employers of the employees.

The third party 300 calculates a predefined discount value for providing increased benefits to the employees for a certain health insurance premium. The predefined discount value is calculated for groups comprising a minimum number of companies or employees. The predefined discount value is applicable to all the companies within the group such that overall volume discount provided to all the companies will have lower health insurance premium and better benefits than the insurance premium and benefits available to the companies individually.

The minimum participating provider organization (PPO) premium or minimum health maintenance organization (HMO) premium currently being paid by the largest employee pool size is selected as a current initial base line price and benefit level for the combined group at renewal time of the health insurance plan. Consider an example of a first employee pool size of 100 employees and a second employee pool size of 50 employees. The first employee pool size comprises employees enrolled for a health plan “A” with a premium of $1000 per month. The second employee pool comprises employees enrolled for a health plan “B” with a premium of $2000 per month. The initial base line premium price for the group comprising the first and second employee pool is selected as $1000 per month. Further, the difference between premiums of companies with higher premium value and the current initial base line price and benefit level will be negotiated by the third party 300 in the scenario of increased combined employee pool. The increased combined employee pool may trigger in further reduction in employee or employer contribution or result in better benefits for all the employees or both. The health insurance company may gain larger market share and revenue for the increased combined employee pool.

The third party 300 may also collect identification information and critical health information from the employees. The identification information includes biological identification information, physical identification information, hand written signatures, and personal identification information of the employees. The critical health information of the employees include computed tomography (CT) scan report, magnetic resonance imaging (MRI) scan report, X-Ray report, current and past medications of the employees, and the medicine dosage levels and frequency.

The identification information is used to authenticate the employees by authorized personnel. The authentication may be through bio-authentication of the employees. Bio-authentication is a technique used to identify an individual based on the biological features of the individual. The biological features may be based on one or more of fingerprint identification, handprint identification, deoxy-ribose nucleic acid (DNA) identification, and iris based identification. The authorized personnel including one or more of physicians, legal authorities, and the health insurance companies are provided online access to the critical health information of the employees. The critical health information is accessed online during critical condition of the employees, for example, memory loss, paralysis, stroke, etc. The critical health information may be accessed using a secure mechanism, for example, a double password protected instantaneous access and display mechanism for accessing the employee's medical history. Further, retrieving online critical health information of the employees may improve quality of health care provided to the employees by the attending physicians and may reduce the liability of health insurance companies. Furthermore, authenticating the employees enables the authorized personnel to detect fraud such as unauthorized billing of the employees.

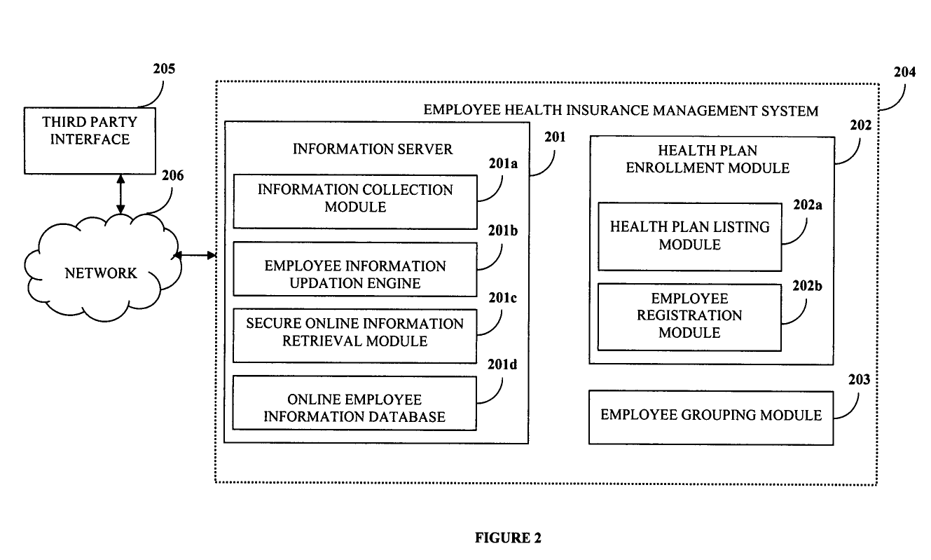

FIG. 2 illustrates a computer implemented system for providing increased health insurance benefits to employees of business entities for an insurance premium charge. The computer implemented system comprises an employee health insurance management system 204 and a third party interface 205 connected via a network 206. The employee health insurance management system 204 comprises an information server 201, a health plan enrollment module 202, and an employee grouping module 203. The information server 201 further comprises an information collection module 201a, an employee information updation engine 201b, a secure online information retrieval module 201c, and an online employee information database 201d.

The information collection module 201a collects health plan requirements, identification information, and critical health information of the employees of the business entities. The employee information updation engine 201b updates the health plan requirements, the identification information, and the critical health information of the employees. The secure online information retrieval module 201c retrieves the critical health information of the employees. The online employee information database 201d stores the health plan requirements, the identification information, and the critical health information of the employees.

The health plan enrollment module 202 enrolls the employees for one or more of health plans. The health plan enrollment module 202, further comprises a health plan listing module 202a and an employee registration module 202b. The health plan listing module 202a lists the health plans from a plurality of health insurance companies to be proposed to the business entities by a third party 300. The health plan listing module 202a enables the third party 300 to propose the health plans to the business entities via the third party interface 205. The employee registration module 202b registers the employees for the health plans. The employee grouping module 203 combines the employees into groups based on the health plans chosen by the employees and geographic location of the business entities. The third party 300 negotiates with the health insurance companies regarding the health insurance benefits and insurance premium charges offered for the combined employee groups.

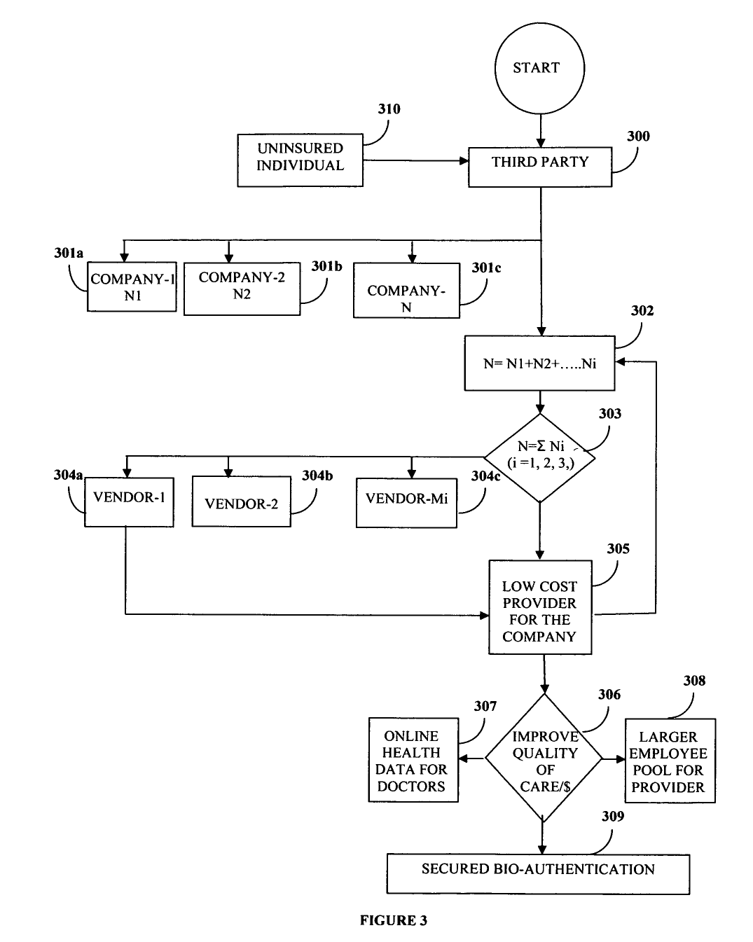

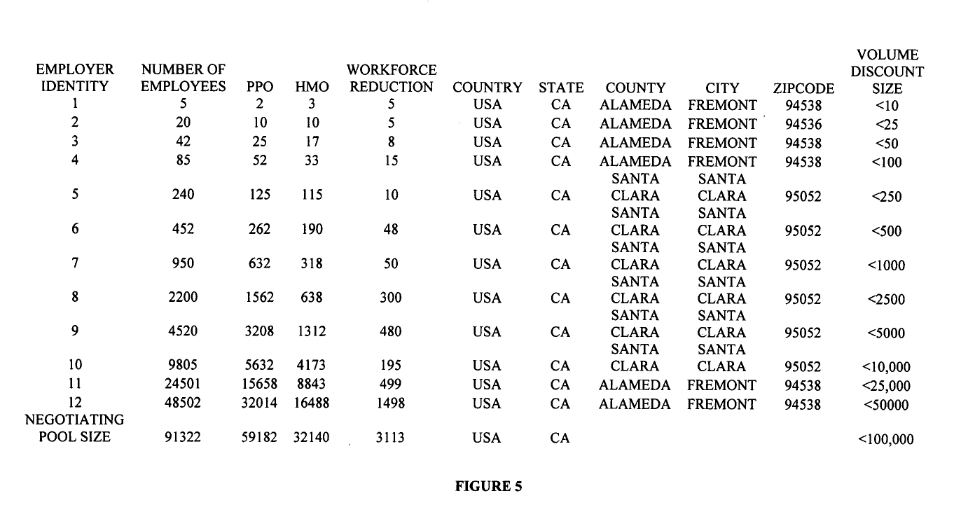

FIG. 3 exemplarily illustrates a flow chart of the steps involved in increasing benefits to the employees of companies. A third party 300 collects information from the employees. The companies may be, for example, company 1 301a, company 2 301b, and company N 301c in the FIG. 3. The employees of the companies are combined 302 into groups by the third party 300. The groups are formed based on the health plans chosen by the employees and the geographical location of the companies. The multiple companies are selected 303 until a predefined discount value “Ni” is arrived upon. For example, the predefined discount value, Ni, may have the value 12. The third party 300 may add the number of companies until the total number of companies adds up to 12. The predefined discount value is the minimum number of companies needed to be added in such a way that overall volume discount provided to all the companies will allow lower health insurance premium or better insurance benefits. The overall volume discount may be predefined for providing health insurance to at least one uninsured individual 310 free of cost. Exemplarily, the overall volume discount for a predefined number of employees of different business entities is exemplarily illustrated in FIG. 5.

Further, the third party 300 negotiates with multiple insurance companies, for example vendor 1 304a, vendor 2 304b, etc. as illustrated in FIG. 3. The quality of care is therefore improved 306 by providing 305 low cost insurance providers to the companies, providing 307 online health data to the doctors, providing 308 a larger employee pool to the insurance provider, and enabling secured bio-authentication 309 for employees. Bio-authentication is a technique used to identify an individual based on the biological features of the individual. The critical health information of the employees is made available in real time for accessing the critical health information at any time and from any place. Further, the critical health information of the employees is accessed by authorized personnel through voluntary bio-authentication of willing employees. Furthermore, by accessing the critical health information at any point of emergency by the attending authorized personnel such as physicians using bio-authentication may save lives if the employees are in an unconscious state. The bio-authenticated retrieval of the critical health information of the employees will reduce medical errors, reduce liability to attending physicians and employers, and decreases cost to the health insurance company.

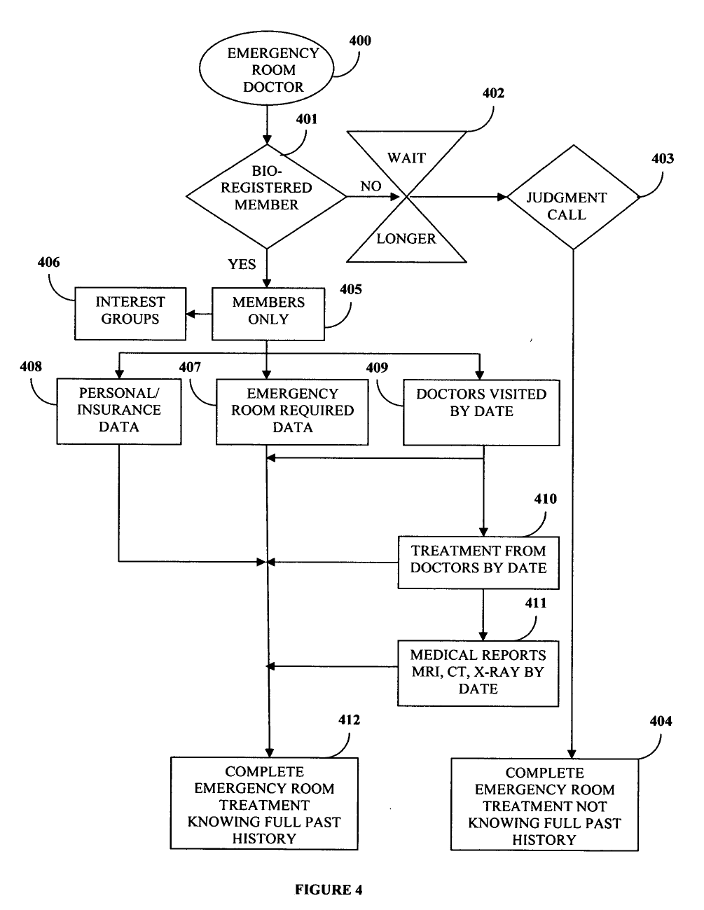

FIG. 4 exemplarily illustrates a flow chart of the steps involved in providing emergency care to an employee utilizing health care information of the employee collected by the third party 300. Consider an employee, who is in a critical health condition or who may be in an unconscious state, is attended by an emergency room doctor 400. If the employee is not a bio-registered member 401 then the employee has to wait longer 402 in order to provide past health information to the doctor 400. Further, if the employee is in an unconscious state, the emergency room doctor 400 may make a judgment call 403 and perform complete emergency room treatment without knowing full past history 404 of the employee.

If the employee is a bio-registered member 401 then the employee is bio-authenticated for retrieving the past medical history of the employee. The doctor 400 may identify the employee as a member only 405 or a member of interest groups 406. The interest groups 406 may include groups for premium reduction via group insurance, groups to cover uninsured individuals, groups for universal health coverage, or Medicare groups. Further, the doctor 400 may retrieve emergency room required data 407, employee's personal and insurance data 408, doctors visited by date 409 data, treatment by doctors by date 410 data, and medical reports 411 such as MRI scan report, CT scan report, and X-ray report by date. Based on the retrieved data of the employees, the doctor 400 will know the full past history and may perform complete emergency room treatment knowing 412 the full past history of the employee.

FIG. 5 exemplarily illustrates the employee pool data used by a third party 300 for negotiating with health insurance companies regarding health insurance benefits and insurance premium charges. The third party 300 may contact employers of an organization and may further collect health insurance related information of employees. The table illustrated in FIG. 5 includes the number of employers, number of employees associated with each of the employers, the number of employees in each company who are enrolled in a participating provider organization (PPO), the number of employees in each company who are enrolled in a health maintenance organization (HMO), work force reductions in each company, address details of each company, and a predefine discount value for each company.

A predefined discount value determines the predefined number of employees who may be given the health insurance at discounted rates in a company. The table also displays the total number of employees associated with the third party 300, the total number of employees associated with the PPO, the total number of employees associated with the HMO, the total work force reductions of the employees, and the total number of employees who may be given the health insurance at discounted rates. The third party 300 uses the information of the total number of employees of the business entities associated with the third party 300 to negotiate with the health insurance companies for providing better health insurance benefits and lower insurance premium charges.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A ‘processor’ means any one or more microprocessors, Central Processing Unit (CPU) devices, computing devices, microcontrollers, digital signal processors or like devices. The term ‘computer-readable medium’ refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described such as the online employee information database 201d, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, etc. that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A computer implemented method of providing increased health insurance benefits to employees of business entities for an insurance premium charge, comprising the steps of:
collecting health plan requirements from said employees of said business entities by a third party;
proposing health plans from a plurality of health insurance companies to the business entities by said third party, wherein said health plans are proposed based on said collected health plan requirements;
choosing the health plans by each of the employees of the business entities;
combining the employees into groups based on said chosen health plans and geographic location of the business entities, wherein said step of combining the employees is performed by the third party; and
negotiating with said health insurance companies regarding said health insurance benefits and insurance premium charges offered for said combined employee groups by the third party;
whereby said negotiation by the third party on behalf of the combined employee groups with the health insurance companies increases the health insurance benefits for said insurance premium charge.

2. The computer implemented method of claim 1, further comprising a step of collecting identification information and critical health information from the employees by the third party.

3. The computer implemented method of claim 2, further comprising a step of providing access to said critical health information of the employees to authorized personnel, wherein said authorized personnel includes the health insurance companies.

4. The computer implemented method of claim 1, wherein the step of combining the employees into said groups comprises selecting the employees from one or more of the business entities.

5. The computer implemented method of claim 1, wherein said groups include groups for premium reduction via group insurance, uninsured individuals, groups for universal health coverage, and medicare groups.

6. The computer implemented method of claim 1, wherein said step of negotiation comprises negotiating with the health insurance companies by the third party regarding availability of critical health information collected from the employees, wherein access to said critical health information during critical conditions of the employees reduces liability to the health insurance companies.

7. The computer implemented method of claim 1, further comprising a step of calculating a predefined discount value for providing discounted health insurance premium and said increased health insurance benefits to the employees.

8. A computer implemented system for providing increased health insurance benefits to employees of business entities for an insurance premium charge, comprising:
an information server comprising:
an information collection module for collecting health plan requirements, identification information, and critical health information from said employees of said business entities;
a health plan enrollment module for enrolling the employees for one or more of health plans provided by a plurality of health insurance companies, wherein said health plan enrollment module comprises:
a health plan listing module for listing said health plans to be proposed to the business entities by a third party, wherein said health plan listing module enables said third party to propose the health plans to the business entities via a third party interface; and
an employee grouping module for combining the employees into groups based on the health plans chosen by the employees and geographic location of the business entities.

9. The computer implemented system of claim 8, wherein said information server further comprises an employee information updation engine for updating said health plan requirements, said identification information, and said critical health information of the employees.

10. The computer implemented system of claim 8, wherein said information server further comprises a secure online information retrieval module for retrieving said critical health information of the employees.

11. The computer implemented system of claim 8, wherein said information server further comprises an online employee information database for storing said health plan requirements, said identification information, and said critical health information of the employees.

12. The computer implemented system of claim 8, wherein the health plan enrollment module further comprises an employee registration module for registering the employees for the health plans.

13. A computer program product comprising computer executable instructions embodied in a computer-readable medium, wherein said computer program product comprises:
a first computer parsable program code for enabling collection of health plan requirements, identification information, and critical health information from employees of business entities by a third party;
a second computer parsable program code for listing health plans from a plurality of health insurance companies to be proposed to said business entities by said third party, wherein said health plans are proposed based on said collected health plan requirements; and
a third computer parsable program code for combining the employees into groups based on the health plans chosen by the employees and geographic location of the business entities, wherein said step of combining the employees is performed by the third party.

14. The computer program product of claim 13, further comprising a fourth computer parsable program code for providing access to said critical health information of the employees to authorized personnel, wherein said authorized personnel includes said health insurance companies.
